(19) United States
(12) Patent Application Publication
(10) Pub. No.: US 2017/0169625 A1
(43) Pub. Date: Jun. 15, 2017

(54) DEVELOPING AND USING A VEHICLE DIAGNOSTIC DISTRIBUTED DATABASE

(71) Applicant: Scope Technologies Holdings Limited, Geneva (CH)

(72) Inventors: Samuel Lavie, Johannesburg (ZA); Gil Emanuel Fuchs, Nes Tziona (IL)

(21) Appl. No.: 15/010,055

(22) Filed: Jan. 29, 2016

Related U.S. Application Data
(60) Provisional application No. 62/265,215, filed on Dec. 9, 2015.

(51) Int. Cl. G07C 5/00; G06F 17/30; H04H 20/55; G07C 5/08; H04L 29/08

(52) U.S. Cl. CPC G07C 5/008; G07C 5/006; G07C 5/0808; G07C 5/085; H04L 67/303; H04L 67/26; H04H 20/55; G06F 17/30979

(57) ABSTRACT

Described herein is a system and method of use for a vehicle diagnostic distributed database. One or more central servers are configured with a database containing diagnostic information pertaining to vehicles and relative to input received by the central server/s from client devices. The central server is configured to upload and download information with in-vehicle and external to vehicle diagnostic systems. These tasks are performed by first having the central server/s broadcast a message over open airways (for example, FM sidebands) to all potential client devices of interest. The message contains information identifying specific characteristics of client devices that should respond and further information about the information that is desired to be uploaded to the central server/s or for downloaded to the clients of interest. If clients meet the broadcast criteria, they then establish two-way communication with the central server/s and fulfill the request.

### CROSS-REFERENCE TO RELATED APPLICATIONS

This application claims priority to provisional patent application U.S. 62/265215 entitled DEVELOPING AND USING A VEHCILE DIAGNOSTIC DISTRIBUTED DATABASE, filed on 9 Dec. 2015 and is herein incorporated by reference.

Determination of patterns that can be used to predict or detect accidents and the results of accidents are described in: U.S. Patent Application titled “SYSTEM AND METHOD FOR USE OF PATTERN RECOGNITION IN ASSESSING OR MONITORING VEHICLE STATUS OR OPERATOR DRIVING BEHAVIOR”, application Ser. No. 13/679,722, filed Nov. 16, 2012; which claims the benefit of priority to U.S. Provisional Patent Application No. 61/578,511, filed Dec. 21, 2011; PCT/US12/71487 titled “SYSTEMS AND METHODS FOR ASSESSING OR MONITORING VEHICLE STATUS OR OPERATOR STATUS” filed 21 Dec. 2012; and Ser. No. 14/317624 titled “System and Method for Determining Of Vehicle Accident information” file on 27 Jun. 2014; each of which the above applications are herein incorporated by reference.

### COPYRIGHT NOTICE

A portion of the discolsure of this patent document contains material which is subject to copyright protection. The copyright owner has no objection to the facisimile reproduction by anyone of the patent documents or the patent discolsure, as it appears in the Patent Trademark Office patent file or records, but otherwise reserves all copyright rights whatsoever.

### FIELD OF INVENTION

Embodiments of the invention are generally related to systems and methods to diagnose vehicle issues and related to communication among components of a distributed vehicle database.

### BACKGROUND

The amount of data that potentially can be stored in a vehicle analytics database is huge—many, many terabytes. The data is not always useful in all areas or regions or for all types of vehicles and situations and may never be used. Therefore, to centrally locate all the information requires unneeded data transferred over limited infrastructure and bandwidth.

The present system alleviates potential bandwidth deficiencies and needless transfer costs for a vehicle analytics database, storing all the information in a distributed fashion, and only relaying information to a processing unit when it is needed for analysis. By having an analysis unit selectively querying across a network or networks for only the pertinent data for a relative event or task and by also identifying what type of device and/vehicle the information is desired from, then massive data transfers can be avoided.

### SUMMARY

Typical vehicle diagnostic systems and assisted or autonomous driving systems rely on crowdsourced information that was compiled from collecting data stored in on-board vehicle systems and from external feeds such as traffic and weather. All this information is compiled and sifted through in an effort to, for example, provide a prediction of some type of hazardous conditions or need of repair. Tremendous amounts of data need to be wirelessly transmitted, typically on mobile networks, where two-way communications are established between every vehicle or external feed and the central server or servers.

Embodiments of this invention drastically reduce the bandwidth necessary to collect and utilize information. When information is desired from specific class of vehicle, or from a web service or radio transmission service, a central server/s broadcasts via radio transmission (for example FM sideband) a selective query which contains specific identifiers with respect to the type of vehicle or vehicle configuration (if necessary) and/or location and time requirements and a request for information, or a notification that information is available for client systems meeting the selection criteria. If a client system receives the transmission and the client system meets the selection criteria, then and only then will a two-way communication be established with a handshake initiated by the client/s (an individual vehicle or subsystem or service).

If the radio transmission was a notification, then the qualifying clients connect to the server/s and download the information. By not establishing a two-way communication with vehicles on the road that do not meet the criteria of the query, bandwidth will always be saved. Furthermore, the server/s does not have to be aware of every vehicle on the road. The vehicles simply have to be aware of the server/s.

Embodiments of this invention comprise a distributed database and method of use, where the database comprises raw sensor and environmental data related to a vehicle and the driving conditions the vehicle was subjected to. All information is both spatially and temporally referenced. In addition the information is referenced based on the type of vehicle and how the vehicle is equipped/loaded and optionally by the driver of the vehicle.

The database is distributed among one or more central servers and clients: satellite servers, individual vehicles, and hand-held units. Each server and clients houses a database of information that is pertinent to one of: one or more vehicles or to an individual driver who drives the one or more vehicles. For example, a vehicle will store raw sensor data from sensors embedded in the vehicle and/or that reside in-vehicle and also information acquired from external feeds—for example traffic (in the vicinity of the vehicle or along a route the vehicle will travel) and weather information. A satellite server will contain, for example, information for vehicles and weather and the transportation network for a given geographic area. Another example is a server hosted by a repair facility that has information on the type and cost of repairs for vehicles they have worked on.

In addition to raw sensor data being stored, patterns or indicators that relate changes in one or more sensor readings over time and changes in environmental data overtime to events that are also stored.

### Glossary:

Maintenance Report: a document or report (either hardcopy or online) that results from analysis of information relating to a vehicle operation, that schedules maintenance and repairs that are required to keep a vehicle in peak operating condition.

In-vehicle: Refers to anything that is part of the vehicle or within or attached to the vehicle.

Sensors: measurement devices which measure parameters that are directly or indirectly related to the amount and extent of maintenance and/or repair needed to keep a vehicle in peak operating condition. Sensors could be in-vehicle—either part of the vehicle or an after-market attachment to the vehicle such as a fleet management system or as part of a mobile device within the vehicle such as the sensors in a mobile phone—like accelerometers or gyroscopes. Sensors may also be outside the vehicle such as roadside traffic counters in the vicinity of the vehicle, weather stations, and satellite or airborne based sensor such as LIDAR. External sensors that can provide information about the condition of pavement, weather, freeze thaw conditions or the like are included.

Transceiver: A device capable of both receiving and sending information to another device whether it be wired or wireless. Examples are two-way radios, mobile phones, wired modems and the like.

Transmitter: A device capable of sending information over radio waves.

Receiver: A device capable of receiving information over radio waves.

Location: where an object is relative to a reference frame. The location of a vehicle is some embodiments is relative to the earth in terms of a coordinate system such as latitude and longitude (and perhaps elevation).

Vehicle: any object capable of moving material or people. This includes cars, trucks, boats, airplanes, construction equipment and the like.

External Observations: See the definition of sensors above for examples of observations that can come from outside the vehicle. Source for this information can also be from web services, for example weather data, or traffic information that is a feed coming in from a FM sideband via an FM receiver.

Reference (for a database): an index or other attribute that can be used to select database records of interest by querying using the index or attribute. For example, reference for accident information could be: location, time, time of day, time of week; make of vehicle, year of vehicle (or Vehicle Identification Number), weather conditions, location of impact (zone on the car), direction of impact, force of impact and the like.

Normalized: transforming data from a variety of sources into the same units, in the same frame of reference.

Historical Maintenance Database: a database or collection of linked databases containing information that is related to individual accident events where all information is cross referenced so that it can be used for statistical analysis of accidents and the cost of repair resulting from the accident.

Cross-referenced: With respect to a database, one entry can be queried as to its relationship to another if there is some type of relationship between the two. For example, a certain model of water pump produced by General Motors may have been used in a variety of car models over a variety of model years, so the part number for the water pump will be cross referenced to vehicle model number, year, engine type. Also note these parameters may not be sufficient information, because a part used may change mid-model year. For example, a wheel type my not be compatible halfway through a model year because the lug spacing was changed for safety reasons. In this case, the wheel would have to be referenced to the specific Vehicle Identification Number (VIN) which could be further cross referenced to a linked database containing more detailed information.

Confidence Interval: One method of expressing the probability that an outcome will be observed to happen within a specific range for a given set of circumstances. For example, the probability that the water pump will have to be replaced for shortly after 100,000 miles of driving is 95 percent for a Ford Focus and 92 percent for a BMW 928i.

Satellite Servers: Part of the network that contains the distributed database where a portion of the database is held. Typically, the portion of the database will have information pertaining to a particular geographic area or a particular fleet of vehicles, or may contain only certain types of information, for example snow depths.

With respect to satellite servers that contain regional information, these databases may contain accident information that identifies damage specific information, and cost of repair with is correlated with make, model, and model year of the vehicle/s involved. Once again this information is spatially and temporally indexed. In addition, weather related information may also be stored and indexed to location and time as well as correlated with accidents. This information can come from police reports, private insurance databases, and similar.

Patterns: Time series or frequency distribution of sequential sensor data of one or more sensors or feeds for a given time period and locale that can be used to identify Driving Events. Patterns are created by analyzing many datasets with known events happening. Patterns are updated by a central server in communication with a vehicle or satellite server system through the process of querying the vehicle fleet or satellite server network and where one of these remote entities has information that match the query, the remote entity will respond with relaying data for the event in question back to the main server. Definition of new patterns are further refined by soliciting data from like vehicles or circumstances, to be relayed to the central server where these data can then be used to refine the existing patterns that define an event.

Patterns typically cannot be determined by human observation as they may be dependent on many variables that do not lend themselves to human observation. A human may be able to observe that the necessity of applying the brake while traveling around a curve is probably indicative of too much speed, however, combining observations of brakes, abs sensors, acceleration, weather feeds and more is beyond the ability of a human to assimilate.

Patterns may be based on the output of 1 or more sensor and/or 1 or more observations. The pattern could be based on exceeding (or falling below) a threshold value, or exceeding (or falling below) an average value over time. Patterns may be analyzed in the frequency domain (after a fast Fourier transform is applied to time series data).

Examples of patterns based on time series or frequency analysis of sensor traces:
Impact severity and direction of impact;
Hazardous driving
Dangerous Roads Segments or Intersections
Probability of Hazardous Driving Conditions for a given location
Excessive Speed

Patterns based on location and/or time:
Road locations
Traffic density
Speed of Travel

Indicators: Readings from one or more sensors for a given time period and locale that exceed or fall below a specified threshold value indicative or an Event, or Situation. An example of an indicator is exceeding the speed limit.

Assessment: Given a variety of patterns and indicators as input, predictions are made for the resulting cost or extent of an event associated with the patterns and indicators.

Driving Events: Something of interest that happens related to a vehicle, location, or time period which is identifiable by monitoring patterns or indicators. Events generally are categorized by something that is out of the ordinary. Examples of an event are a vehicle accident, a vehicle exceeding the speed limit, a vehicle being driven in an unsafe manner. An Ongoing Driving Event is a subset of an Event where the event occurs over a period of time. For example, an accident may be a momentary event, but may cause an Ongoing Event such as a slowing of traffic on the road where the accident occurs

External Data Feeds: Servers or services that available via a web interface or that are broadcast over radio frequency that provide information on conditions such as weather and traffic.

Situation: Something that is associated with the likelihood that an event will happen for a particular place, time and/or conditions. For example, a particular curve in the road may be more dangerous if a certain safe speed is exceeded or if the road is icy or wet. Therefore, if a specific vehicle is traveling on a specific curve and that curve happens to be icy, and the vehicle weighs a specific amount, then the situation may be that the vehicle is in eminent danger of sliding off the road.

Mutli-variate analysis: A statistical technique to identify or maintain patterns. Examples are artificial neural networks and machine learning.

Circumstances: Background information related to individual events. For example, location, time, weather conditions, traffic, road condition are all circumstances.

### BRIEF DESCRIPTION OF THE FIGURES

FIG. 1 is a depiction of an embodiment of a system that houses a distributed vehicle diagnostic database.

FIG. 2 is a flow chart of an embodiment of a method of using a distributed vehicle diagnostic database.

FIG. 3 is a flow chart of an embodiment of a method for follow up instructions after an event has occurred and been reported.

FIG. 4 is a flow chart of an embodiment of how patterns and indicators are updated.

### DETAILED DESCRIPTION

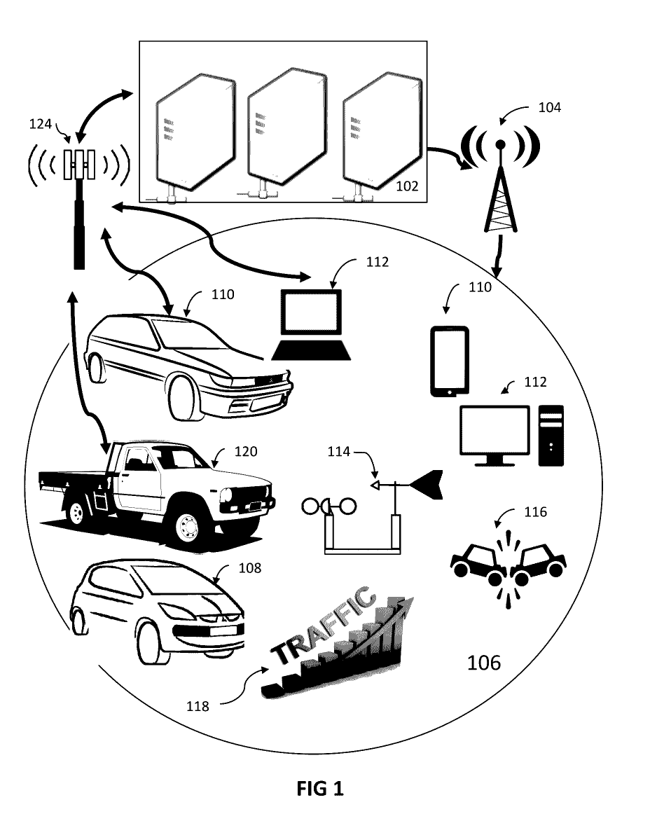

FIG. 1 is an example of a distributed vehicle database system. System hardware is distributed between one or more central servers 102 and client systems 106. The client systems can include, for example, passenger vehicles 108, trucks 120, satellite servers 112, external data feeds, such as weather 114 and traffic 118, on-board vehicle systems and portable devices 110.

Information is communicated in the form of a query or a notification from the one or more central servers 102 to clients 106 via a radio broadcast 104. All clients have a radio receiver that conforms to the radio frequency and standard of broadcast as the radio broadcast device connected to the central server/s. All of the clients 106 in range of the broadcast receive the broadcast and digest the query or bulletin. If the query or bulletin pertains to the particular client 106, each client 106 establishes two-way communication, for example, over a mobile network 124, with the central server/s 102and uploads to the central server/s 102 the requested information for a query or downloads the available information to the clients 106 for a bulletin.

As not all data are needed for every situation, the data are maintained in the device or system where it was generated and/or in a regional client of some kind. All data does not need to be uploaded to a central server for storage and subsequent analysis unless a central server asked for it.

Below are examples of data that could be stored:
raw sensor data recorded as time histories

accelerometer readings over time
all sensors that can be queried via a vehicle diagnostic port (onboard diagnostics OBD) including: mass flow, oxygen, seat belt, air bag, tire pressure, gps, accelerometers, gyroscope, and more.
sensor data derived from mobile or 3rd party devices within the vehicle—including accelerometers, gyroscope, air pressure, gps.
VIN, and/or make model and model year, accessories such as larger than normal tires, engine type and size, etc.
Wheel diameter
Tire tread pattern/age of tires/inflation pressure

Characteristic about the load in the vehicle (could for example be provided by RFID tags on cargo or passengers)
Number of passengers
Gross and Net Vehicle Weight
Load distribution
Environmental sensors and feeds either from on-board vehicle sensors or sensors external to the vehicle

The driver may be identified either by manually input, or via automatic connection between the vehicle and a mobile device of the driver, or by visual or audible input query by controlling software within the car. These are just examples and any type of identification of the driver could be used. The driver could carry an RFID tag that identifies her, for example.

Information relayed from roadside sensors or sensors or devices that monitor road conditions or weather can be stored. These can come from Bluetooth connections, side bands on radio stations (for example traffic); internet feeds and peer-to-peer networks from other vehicles.

Other information may concern repair history of warn vehicle parts as related to all the above mentioned information. This information could be stored directly in a server at a repair shop—for example.

### Method of Use

All information stored in the distributed database is optionally spatially and/or temporally referenced. In addition, the information can be referenced based on the type of vehicle and/or how the vehicle is equipped and/or by the driver of the vehicle. Patterns that relate changes in one or more sensor and environmental data overtime to events are also stored in the database, both in vehicles were the patterns are pertinent and in a central database located on a central server or in satellite databases.

Patterns are created by analyzing many datasets with known events happening and developing a predictive model of the event based on the available data. Patterns are updated by a central server in communication with client systems through the process of querying the client system (such as a vehicle fleet) and having clients (vehicles) that match the requirements for the pattern, respond with relaying data for the event in question.

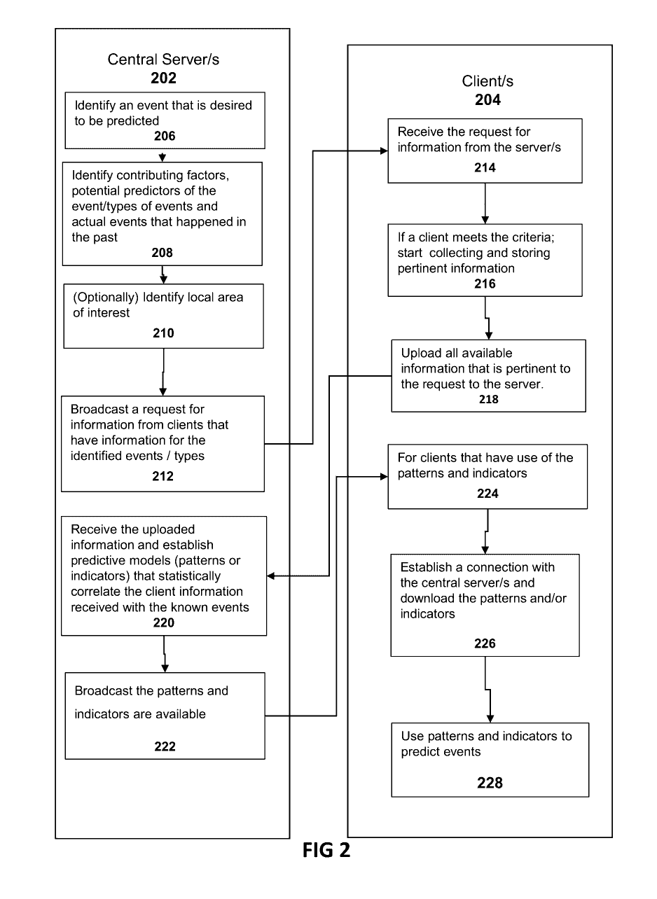

FIG. 2 explains how an embodiment of the system is used. The system consists of one or more central servers 202 equipped with one or more processors and one or more client devices 204 (see client devices as depicted in FIG. 1). The central server/s is configured with software to predict events and to make assessments. The central server/s is further equipped with a list of events of interest.

To predict an event, the central server/s 202 needs to correlate potential contributing factors to particular events or types of events 206. In some embodiments, the prediction or assessment is of regional or local in interest only and this will effect what sources of information are used 210. The central server/s 202 broadcasts, using a radio broadcast transmitter, a request to all potential clients 204 including identifying parameters of type of information and also what type of vehicle or other source for the information that is needed 212. This request is generated by instructions loaded in one or more processors and referred to as a query engine. Clients 204 are typically listening for broadcasts, using a radio broadcast receiver, from the central server/s 202. Once a broadcast is detected by a client, each client 204 parses the query or bulletin that was broadcast and determines whether it is able to comply with all of the requirements 216. If the client 204 can comply and the request (or query) is for information, the client will 1) relay the requested information to the central server/s 202, using a two way radio transceiver, and/or 2) start collecting the requested information from sensors or other devices. Once a packet of information is acquired, the client 204 establishes a two-way radio communication link using the transceiver and uploads the information 218 to the central server 202 which receives the information on a radio transceiver that is part of the central server/s.

The central server/s 202 then uses a form of statistical analysis to establish a relationship between the uploaded information from numerous clients 204 and creates predictive models 220 in the form of patterns and indicators. A broadcast, using the transmitter, is made to the clients 204 to let them know the derived patterns, and indicators are available for usage 222. Clients 204 that have need of the patterns and indicators 224,then download the information 226, then monitor sensors and other incoming information to determine if patterns or indicators occur that are indicate an event has happened 228.

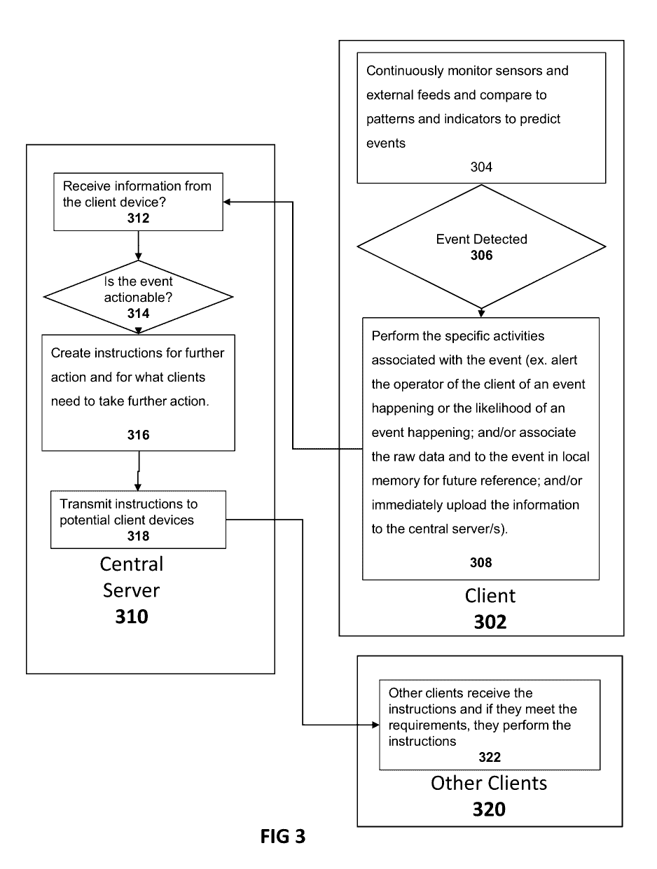

FIG. 3 depicts how certain events trigger other events. A follow-on analysis may be necessary after certain types of events are detected to form a proper assessment of needs to be performed. An example of an assessment would be to indicate how much damage occurs when a vehicle is in an accident. Sensor output could be used to determine the type and severity of impact, and averages of repair bills for similar accidents in the vicinity of the current accident could be used to estimate the cost of repair.

In FIG. 3, a client 302 continuously monitors sensors and external feeds 304 and compares to patterns and indicators to detect an event. If an event is detected 306, pre-programmed activities are initiated that are associated with the event 308. One of these activities may be to inform the central server/s of the event and to upload information pertaining to the event. The client 302 establishes two way communications with the central server/s and then uploads the information and data associated with the event. The central server/s 310 in turn receives the information 312 and determines the type of follow-up information that is needed 314. An example would be, an accident is detected; it is reported to the central server along with particulars about speed, location, severity of impact. The central server may be programmed to determine if the accident caused a traffic slow down; therefore, it would broadcast a bulletin that it is interested in knowing the speed of vehicles that are in the vicinity of the accident so it can determine what, if any, roads were affected by the accident 318. In response other clients 320 that meet the selection criteria would communicate with the central server and upload their speed 322.

In the same scenario above, the central server could also send out a request for available tow trucks that could be dispatched immediately to the scene. Yet another request would be to the insurance company of the vehicle involved in the accident; to emergency responders; and the like to send out a representative to the scene. Another example would be notifying local auto body shops of a potential client.

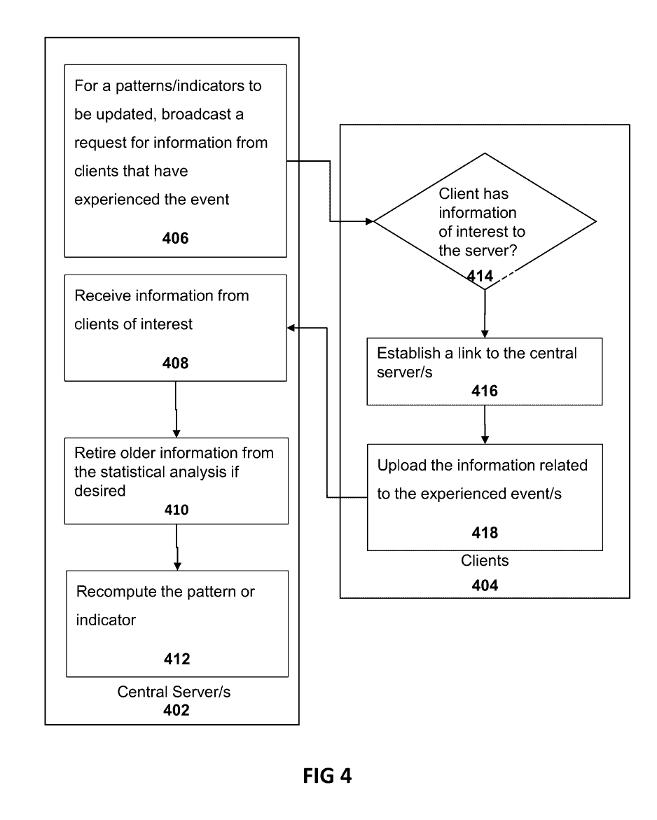

FIG. 4 describes periodic update of the patterns and indicators stored in the system. Patterns and indicators need to be updated by central server/s. This happens by determining when certain patterns are either too old or new information is available that needs to be incorporated. For example, a new sensor reading may have been determined to be useful in prediction of certain types of events and has previously not been included in the patterns for that event. The central server/s 402 would send out a query for additional information to be used for this update including the type of sensor reading that are needed and other pertinent information 406. Potential clients of interest receive the query and determines if they are a client 404 of interest (have pertinent information) 414. Clients 404 of interest establish a link 416 with the server/s 402 and then upload pertinent information 418. The server/s 402 receives the information 408, and retires older information 410 and re-compute updated patterns and indicators 412.

### Normal Mode of Operation

Numerous databases exist that have valuable information for vehicle diagnostics and analysis and for warning vehicles of impending events about to happen. One problem is that all of these databases may have different means of access (different query language, different security, and different accessibility on a network). For a distributed database to work, then all the databases that are a part of the whole, must either be structured in a similar fashion (have the same schema and identifying elements with the same nomenclature) and have a common query language or there must be an intermediate step to translate one schema and one query language to another.

For example, in a vehicle collision database, identification of where damage was sustained on the vehicle and the severity of the damage must be codified so that a central server understands the information provided by a client.

In Table 1,below, is an example of information that might be conveyed in a bulletin using the distributed vehicle database system - regarding a terrorist alert status. The scenario would be as follows: One or more of the central servers received a statement from the department of Homeland Security (a potential client) indicating that there will be an amber alert for a specific geographic area for a specified period.

The information in the alert could be represented with fields defined in table 1and with their XML (extensible markup language) counterpart below that.

### Alert Parameters

alert
A single active alert. Contains the following attributes
   start
The effective start date/time of the alert, in the form YYYY/MM/DD HH:MM, expressed in GMT
   end
The effective end date/time of the alert, in the form YYYY/MM/DD HH:MM, expressed in GMT
   type
The type of the alert. Possible choices are
Imminent Threat
Elevated Threat
   link
a URL to a PDF document which provides further details about the alert
   summary
A short plain text summary of the alert.
   details
A longer explanation of the alert. May contain HTML
   sectors
A possibly empty list of sectors which are impacted by this alert
   sector
An individual sector impacted by an alert. Represented as plain text
   locations
A possibly empty list of locations which are impacted by this alert
   location
An individual location impacted by an alert. Represented as plain text
   duration
A plain text description of the expected duration of this alert May be blank
   detail_{—sections}
A list of information specific to the threat detailed by the alert
   detail_{—section}
An individual detail section containing a specific piece of information for the alert.
   detail_{—title}
An individual detail section title. May contain HTML
   detail
An individual piece of detail related to the threat. May contain HTML

### Alert in XML Format

```
TABLE 1
<?xml version=“1.0” encoding=“UTF-8”?>
  <alert start=“2011/04/14 14:39” end=“2012/04/14 14:38”
  type=“Elevated Threat”
link=“http://www.dhs.gov/xlibrary/assets/ntas/ntas-sample-alert.pdf”>
    <summary><![CDATA[This is a summary of the alert]]></summary>
    <details><![CDATA[<p>This is a more detailed description of the
alert</p>]]></details>
    <locations>
      <location><![CDATA[A location or region]]></location>
      <location><![CDATA[Another location or region]]></location>
    </locations>
    <sectors>
      <sector><![CDATA[An impacted sector]]></sector>
      <sector><![CDATA[Another impacted sector]]></sector>
    </sectors>
    <duration><![CDATA[Freeform text description of the duration of the
alert]]></duration>
    <detail_sections>
        <detail_section>
          <detail_title><![CDATA[Freeform detail title]]></detail_title>
          <detail><![CDATA[<p>Freeform text description of threat
details</p>]]></detail>
      </detail_section>
        <detail_section>
          <detail_title><![CDATA[Freeform detail title]]></detail_title>
          <detail><![CDATA[<p>Freeform text description of threat
details</p>]]></detail>
      </detail_section>
        <detail_section>
          <detail_title><![CDATA[Freeform detail title]]></detail_title>
          <detail><![CDATA[<p>Freeform text description of threat
details</p>]]></detail>
      </detail_section>
        <detail_section>
          <detail_title><![CDATA[Freeform detail title]]></detail_title>
          <detail><![CDATA[<p>Freeform text description of threat
details</p>]]></detail>
      </detail_section>
    </detail_sections>
  </alert>
```

The central server may be programmed to receive the xml above and parse it. Based on the location fields, the type of alert field and the duration, the server may be further programmed to divert members of a fleet of vehicle away from the alert area if they are scheduled to be in the alert area at the specified time. This would happen by broadcasting a request that all members of the fleet of interest to establish a link with the central server and receive further information about the threat level. This would save having to relay the entire message to all vehicles. In addition, the central server would know have a good indication of how many vehicles in its fleet would be impacted by the alert. Of course other scenarios could be treated in the same manner.

In an embodiment of the system and method, the prediction of required maintenance and the estimated cost of maintenance is transmitted to the vehicle when service or maintenance is needed. The transmission can occur to either the in-vehicle system or to a mobile device carried by a driver or passenger or directly to a service technician.

If the analysis is transmitted to the car, results can be displayed either graphically and/or in text on a screen in the vehicle—for example, an infotainment system screen.

### Communication Protocols

For radio broadcast from the central server to client devices communications could for example be using FM side-bands much like Traffic Messaging channels operate. Communication could also be peer-to-peer and/or repeated. For example, the central server/s could broadcast a query or bulletin which is received by a vehicle. The vehicle could then rebroadcast it over a different frequency or using a different protocol—for example Bluetooth.

Communications between various sensors and a processor in a client can happen via the system bus in the client or via short range wireless or via fiber optics or wired connections. If the client device is an add-on product or consists of software running on a mobile device within a vehicle, then communication with the integral vehicle sensor may be by using an interface that can read on-board diagnostic (OBD II) codes by interfacing with a vehicle portal designed for external communications. Another type of code that is somewhat standardized for vehicle diagnostics is the diagnostic trouble codes (DTC).

Many vehicles have Bluetooth or similar short range wireless protocol communication modules and can transmit information such as DTC codes to nearby devices. Longer range telematics devices that use, for example, mobile phone communication methods, also exist that can transmit DTC codes or similar code to a central location

If the vehicle data collection module has software running on a general purpose computing device such as a mobile phone, the phone or other device could be plugged into the vehicle using a wired means such as a Universal Serial Bus (USB) or short range wireless such as Bluetooth.

Sensor that are part of the mobile device can also be considered in-vehicle sensors provided the device is in or attached to the vehicle. These types of sensors can include gyroscopes, accelerometers, altimeters and GPS, for example. Communication with these sensors would be over the data bus of the portable device.

For client device that are in a stationary location, for example, road side sensor suites, an autobody repair facility, communication to a certain server or other nodes could happen over the internet and/or other form of wired and/or satellite communication.

In addition, a client device may communicate with a central server and/or a client device using a per-to-per network where a message is transmitted to one or more other client devices and then the message is repeated for other client that are in communication with the transmitting client device.

### Database Design and Input Normalization

In embodiments of this invention, vehicle maintenance and service requirements are predicted by comparing the observed conditions that occur during vehicle operation over time with similar observed conditions for similarly classed vehicle used in similar conditions stored in a historical vehicle maintenance database. Algorithms are developed to classify each maintenance or service event as succinctly as possible, given the available data, such that when the conditions requiring maintenance or service for a vehicle in use match a classification, this can be used with a degree of certainty, to predict resulting maintenance required and the parts and services necessary to effect the maintenance.

In an embodiment, the observed conditions of interest during vehicle operation include:

### Specific Type of Vehicle, Including Make, Year, Model, Weight and Options

Condition of the vehicle (prior damage, corrosion, state of repair)
Maintenance and Repair History
Accident History
Locale of vehicle operation (for determination of regional variable costs)
Environmental factors (weather, road conditions) during operation

Raw data that may be used to predict maintenance and service needed can come from a plurality of sources. Sources include:
In-vehicle Sensors
   Accelerometer to measure starting and stopping, rapid turning
   ABS sensors to detect when slippery conditions occur
   Gyroscope to erratic driving patterns
   GPS for speed and direction of travel
   Seatbelt sensors
   Engine sensors such as oxygen, rpm, pollution control, temperature, etc
External Sensors
   Weather from web services
   Traffic information from web services or FM sideband (Traffic Messaging Channel)
   Road Condition Information from web-sources such as highway departments
   Other means of collecting information
   Fleet Maintenance Reports (subsequently manually entered into the system database by manual entry using a computer interface application
   Repair Shop Invoices
   GIS information (speed limits where traveled and roads traveled)
   A listing of parts replaced
   Price of labor (preferably broken out by part installed or service performed)
   Price of parts
   Time between suggested maintenance and it actually occurring
   Amount of lost time failures when maintenance suggestions are followed vs when maintenance lags

The database initially will have a mix of more qualitative data, for example from manually entered fleet maintenance records and repair shop invoices and quantitative data, for example, from in-vehicle sensors. As such there is a subjective element in the reporting and the likelihood of human error will reduce the quality of the manually entered data and therefore if the manually entered data makes up the bulk of the available information, the error in prediction of maintenance will be greater.

In addition, since much of qualitative information would have initially have been manually entered on a piece of paper, there will also be transcription errors regardless of whether the information is manually input into the database by a human or if the information is machine input using optical character recognition and algorithmic processing of the text.

Available information to input into the database will change with time. As more information of a quantitative nature or more precise, accurate and with less bias information becomes available, older more qualitative data will be replaced and the resulting predictive model or associated statistics will be updated to reflect the new data.

For information from disparate sources to be compared, the information must be normalized, i.e. converted to the same units of measure and be relative to the same reference frame. In addition, the quality and precision of the data must also be evaluated and represented within the database in a normalized fashion. In other words, if for example, one speed is known to be accurate within +/− 10 mph, then all speeds in the database should have an error of estimate in mph (as opposed to kph for example).

### Components of the System

The following components are parts of embodiments of the system described in this application:
One or more central servers that contain:
   Computer memory loaded with:
      a comprehensive database and patterns and indicators that correlate to events and situations
   One or more processors containing:
      Instructions for when and how to transmit requests for information and/or bulletins
      Instructions for receiving and analyzing information from remote devices
   Communications Devices
      One-way transmitter of binary digital data containing:
         Coded requests for information including:
         Identification of the information requested
         Optional: Identification of the type of vehicle and/or components required by for a respondent
         Optional: Geographic Area of Interest
         Optional: Time period of Interest
   Radio Transceiver used to upload and download information to one or more specific client systems after two-way communication has been established by the client
Vehicle Systems and / or Portable Devices
   Radio Receiver for information from central servers via the one-way transmitter and/or other vehicles or systems including:
      Query for information
      Updates of patterns and indicators
      Updates on codes that are used to identify fields in a query
      Updates on sensor information and/or external feeds that are available on the network
      Updates on parts inventory that are part of each car
   Radio Transceiver configured to establish two-way communications with one or more central servers and further used to upload and download information
   Sensors (in-vehicle and external to vehicles)
      See listing of sensors elsewhere in this document

### Examples of Use

An example of how to use the above information is that the central server can query the satellite servers for regional information, when, for example, an insurance carrier wants to adjust rates base on region or a fleet management company wants to perform preventative maintenance on their fleet which is region dependent.

An operator of the system may desire to update the geography of a specific road segment. To do this a query may be sent to all vehicle, requesting a download of gps traces for vehicles that have traversed the segment within a specified time period. Vehicles that meet this requirement and that received the query then respond by sending the appropriate information. Once the information is received, then the GPS traces can be processed to revise the geometry or the road segment in the central database. Transportation network information comprises the physical location of roads, the road condition, traffic density throughout the day or week and typical weather conditions for a given time and relative to a road position and more.

Another example of how the distributed database could be used would be, for example, in the current Volkswagen scandal. Suppose it is desired to measure fuel emissions from diesel engines while on the road, yet it is very difficult and expensive to do this directly. By using the relationship between the observed emissions values and the vehicle weight, slope angle the vehicle is driving on, country of origin of the vehicle (depending on country regulations, the vehicle is equipped with different engine features for example), octane level of the fuel, engine rpms, and tire type and inflation a pattern can be determined so that emissions can be measured indirectly. Then it can be determined how often vehicles on the road have emission values that exceed the emissions for the similarly equipped vehicle when run on a dynamometer.

The central processor/s could send out a query request to all vehicles in the network and request that all vehicles with a specific model and model year and that have the specific engine type of interest, record the above parameters over a period of time and transmit that information back to the central server. Alternatively, the vehicles in question will already be recording and storing this information, and can relay this information to the central server for a former time period once it is requested by the central server. Yet another possibility is for the central server to send the stored relationship (pattern or indicators) with the query, so that the individual vehicle systems can determine emission values based on the stored pattern and/or indicators and send only the computed emission values back to the central server.

Another example usage is in comparing vehicle wear as a function of region. Similarly, equipped vehicles will wear out faster or sustain differing levels of damage when involved in an accident depending on where the vehicle is driven. This type of information could be important for determining insurance rates. Corrosion due to salt being used as a de-icer for roads, corrodes vehicle parts significantly faster than when the salt is not applied. Likewise, in an area where there is significant rain, corrosion will be higher than in an arid region.

### Other Use Scenarios

Determining if a detour and/or road construction is still in effect for a particular street segment.
Request issued from Central Server/s: Rate of speed for vehicles traveling a specific road segment within the last day.
Analysis: If no replies: road most likely closed:
   If replies from client devices indicate vehicles are moving slow over the whole day, construction most likely active

Determining why a particular vehicle part broke or wore out.
Request for a response from any repair facility: record of repairs or replacement of the part of interest that has worn out; supply all vehicle information, such as mileage on the part, location, vehicle type, vehicle model, subcomponents related to the part of interest.
Analysis: Cross correlate subcomponents and mileage and vehicle type with the failure. Determine how to avoid the failure and/or determine what set of variable most likely predict the failure.
Broadcast a repair bulletin for the identified vehicle characteristics of interest for when to perform scheduled maintenance based on when the part is anticipated to fail. Send a request to update the database in in-vehicle systems for this particular anticipated failure.

Update the geometry of a road
Broadcast a request for GPS traces of a road from all vehicles driving the road.
Analysis: Merge the traces from the responding vehicles into an average and compare with the existing segment in a navigation database. If the new segment is substantially different, replace the old one, or merge the new one with the old one.
Broadcast that a new update in road geometry is available for download

Update traffic light timing
Request: For all vehicles that are traveling within a defined geographic area, upload the gps trace and traveltime while in the defined area.
Analysis: Determine how long each vehicle had to wait for a traffic signal (i.e. more than once) in all four directions of travel at times throughout the day. Compare with other traffic lights that are in the area. Using traffic modeling determine if changing the timing of the traffic lights would minimize congestion and improve transit speed.
Broadcast to the traffic lights in question that a new timing scenario is available for download.

### Implementations

The present invention may be conveniently implemented using one or more conventional general purpose or specialized digital computers or microprocessors programmed according to the teachings of the present disclosure, or a portable device (e.g., a smartphone, tablet computer, computer or other device), equipped with including one or more sensors (e.g., accelerometers, GPS) or where the portable device are connected to the data collection devices that are remote to the portable device, or that are connected via wired or wireless means. Appropriate software coding can readily be prepared by skilled programmers based on the teachings of the present disclosure, as will be apparent to those skilled in the software art.

In some embodiments, the present invention includes a computer program product which is a non-transitory storage medium (media) having instructions stored thereon/in which can be used to program a computer to perform any of the processes of the present invention. The storage medium can include, but is not limited to, any type of disk including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

### Remarks

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. For example, although the illustrations provided herein primarily describe embodiments using vehicles, it will be evident that the techniques described herein can be similarly used with, e.g., trains, ships, airplanes, containers, or other moving equipment, and with other types of data collection devices. It is intended that the scope of the invention be defined by the following claims and their equivalence.

1. A system to create, manage and utilize a vehicle diagnostic distributed database comprising:
a) at least one central server operable on one or more computers configured with at least:
i) a radio transmitter configured to broadcast a query;
ii) a first radio transceiver configured to perform two-way communications with the one or more client devices; and
iii) a query engine configured to generate a query containing:
(1) a selection criteria for client devices of interest; and
(2) a request to at least one of upload information to the central server and download information from the at least one central server; and
b) the one or more client device configured with at least:
i) a broadcast radio receiver configured to receive broadcasts from the at least one central server station;
ii) a second radio transceiver configured to perform two-way communications with the first radio transceiver in the at least one central server; and
iii) a computer processor configured to receive a query from the broadcast radio transmitter and evaluate if the client device meets the selection criteria and if so, establish two-way communication, using the second radio transceiver, with the at least one central server, and perform the request.

2. The system of claim 1 wherein the query is a request to upload information that is specific for a particular vehicle type or component and related to known vehicle events or situations and comprises one or more of:
a) vehicle component replacement and maintenance records;
b) vehicle sensor data referenced in space and time; and
c) environmental data referenced in space and time.

3. The system of claim 1 wherein the at least one central server is further configured to develop at least one of patterns and indices to predict vehicle events and identify situations based on information, from the one or more client devices, that was previously uploaded to the at least one central server.

4. The system of claim 3 wherein the query engine generates a bulletin apprising clients of interest on the availability for download of, one or more of patterns and indices and instructions for the usage of the one or more patterns and indices and the radio transmitter broadcasts the query.

5. The system of claim 4 wherein the clients of interest establish communication with the at least one central servers using the second radio transceiver and download the patterns and indices to predict events and identify situations.

6. The system of claim 1 wherein the selection criteria comprises at least one of make, model, year of manufacturer and optional equipment of a vehicle.

7. The system of claim 1 wherein the selection criteria comprises at least one of a geographic region, a climate zone, and within a political boundary.

8. The system of claim 1 wherein the request is for GPS traces along roads a client vehicle has traversed.

9. The system of claim 8 wherein the at least one server receives the requested GPS traces and is configured to update road geometry based on the GPS traces.

10. The system of claim 3 wherein the identified events and situations are one or more of:
a) a vehicle accident occurring or having occurred.
b) hazardous driving conditions;
c) hazardous or illegal driving by a current driver of a vehicle; and
d) required vehicle maintenance.

11. The system of claim 1 wherein the at least one client device is one or more of a:
a) vehicle;
b) satellite server or service; and
c) mobile device.

12. The system of claim 10 wherein an assessment for damage or repair costs is made for the identified event or situation.

13. The system of claim 1 wherein the database comprises at least one:
a) vehicle driving situations;
b) vehicle driving patterns and indicators;
c) vehicle components and maintenance records;
d) sensor data referenced in space and time; and
e) remote environmental data referenced in space and time.

14. A communication system used to operate a distributed vehicle diagnostic database comprising:
a) one or more computer based servers configured with at least:
i) a broadcast radio transmitter;
ii) a first radio transceiver; and
b) one or more client devices configured with at least:
i) a broadcast radio receiver;
ii) a second radio transceiver;
wherein the one or more computer based servers transmits, using the broadcast radio transmitter, a request to one or more of upload and download information and further containing selection criteria, and the one or more client devices:
a) listen for and receive the transmission, utilizing the broadcast radio receiver;
b) determines whether the selection criteria are met; and
c) if the selection criteria are met, establish communication between the first and second radio transceivers and perform the request.

15. A communication method used to operate a distributed vehicle diagnostic database comprising:
a) broadcasting a radio transmission, using a radio transmitter that is part of a central server wherein the broadcast contains a query or bulletin including a client selection criteria,
b) listening for and receiving the broadcast, utilizing the broadcast radio receiver that is part of a client device and determining whether the client device meets the client selection criteria, and if the client device meets the client selection criteria, establish communication between a first radio transceiver that is part of the client device and second radio transceivers that is part of the one or more central servers, and moving information between the one or more computer servers and the client device that meets the client selection criteria.

16. Then communication method of claim 15 wherein the information to upload or download comprises one or more of:
a) driving situations;
b) driving patterns and indicators;
c) vehicle components and maintenance records;
d) sensor data referenced in space and time; and
e) remote environmental data referenced in space and time.

17. The communication method of claim 15 wherein the client device is one of a:
a) vehicle;
b) satellite server or service; and
c) mobile device.

18. The communication method of claim 15 wherein the client transceiver of the one or more client devices is configured to also act as a repeater transmitting information to another client device which in turn can repeat the information and further transmit to yet another client or one or more of the computer based servers.
